(19) United States
(12) Patent Application Publication
(10) Pub. No.: US 2026/0235034 A1
(43) Pub. Date: Aug. 13, 2026

(54) Turbine or compressor stage assembly

(71) Applicant: MTU Aero Engines AG, Munich (DE)

(72) Inventors: Andreas HARTUNG, Munich (DE); Markus SCHLEMMER, Munich (DE)

(21) Appl. No.: 19/422,500

(22) Filed: Dec. 17, 2025

(30) Foreign Application Priority Data
Dec. 17, 2024 (DE) 102024138228.7

(51) Int. Cl. F01D 5/22

(52) U.S. Cl. CPC F01D 5/225; F05D 2220/323; F05D 2240/11; F05D 2250/711

(57) ABSTRACT

An assembly including a first component and a second component configured for arrangement in a same turbine or compressor stage of an aircraft engine. The first component has a first surface and the second component has a second surface opposite the first surface. The first surface has a first contact area configured for contacting the second surface. The second surface has a first contact contour opposite the first contact area configured for contacting the first contact area, the first contact contour area having a recess or a convex edge or a convex tip.

### CROSS REFERENCE TO RELATED APPLICATIONS

This application claims benefit to German Patent Application No. DE 10 2024 138 228.7, filed on Dec. 17, 2024.

### FIELD

The present invention relates to an assembly for installation in a turbine or compressor stage of a fluid flow machine, a turbine or compressor stage with the assembly, and a fluid flow machine.

### BACKGROUND

Turbine or compressor stage components or assemblies are excited to vibrations during operation, for example by aerodynamic and/or structural dynamic forces, which place them under stress. It is known from internal company practice that such vibrations can be reduced by energy dissipation and/or energy absorption.

### SUMMARY

In an embodiment, the present disclosure provides an assembly comprising a first component and a second component configured for arrangement in a same turbine or compressor stage of an aircraft engine. The first component has a first surface and the second component has a second surface opposite the first surface. The first surface has a first contact area configured for contacting the second surface. The second surface has a first contact contour opposite the first contact area configured for contacting the first contact area, the first contact contour area having a recess or a convex edge or a convex tip.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an assembly according to an embodiment of the present disclosure;

FIG. 2 illustrates an assembly according to an embodiment of the present disclosure;

FIG. 3 illustrates an assembly according to an embodiment of the present disclosure;

FIG. 4 illustrates an assembly according to an embodiment of the present disclosure;

FIG. 5 illustrates an assembly according to an embodiment of the present disclosure;

FIG. 6 illustrates an assembly according to an embodiment of the present disclosure;

FIG. 7 illustrates a body of the assembly in FIG. 6;

FIG. 8 illustrates a body of a modification of the assembly in FIG. 6;

FIG. 9 illustrates a body of a modification of the assembly in FIG. 6;

FIG. 10 illustrates a body of a modification of the assembly in FIG. 6;

FIG. 11 illustrates an assembly according to an embodiment of the present disclosure;

FIG. 12 illustrates a damper segment of the assembly in FIG. 11;

FIG. 13 illustrates a damper segment of a modification of the assembly in FIG. 11;

FIG. 14 illustrates a damper segment of a modification of the assembly in FIG. 11; and

FIG. 15 illustrates a second component of an assembly according to an embodiment of the present disclosure.

### DETAILED DESCRIPTION

In an embodiment, the present disclosure provides an improved turbine or compressor stage of a fluid flow machine.

Embodiments of the present disclosure provide an assembly with the foregoing improvements. Embodiments of the present disclosure also protect an assembly arrangement or a turbine or compressor stage for a fluid flow machine, in particular an aircraft engine, with at least one of the assembly arrangements described herein, or a fluid flow machine, in particular an aircraft engine gas turbine, with at least one such stage.

According to an embodiment of the present disclosure, an assembly comprises at least two components, which are referred to as the first and second components without limiting their generality.

The assembly is arranged or intended or designed or used in a version of the same turbine or compressor stage, in a further development of a low-pressure turbine stage, in a flow machine, or in a further development of an aircraft engine, preferably an aircraft engine gas turbine. The present disclosure enables the particularly advantageous reduction of undesirable vibrations in an embodiment, in particular speed-synchronous and/or speed-asynchronous externally excited vibrations and/or self-excited vibrations, such as those occurring in turbines and in particular compressors and especially low-pressure turbine stages, particularly in aircraft engines (gas turbines), due to the aerodynamic, mechanical, and thermal loads and design constraints that occur during operation.

According to an embodiment of the present disclosure, the first component has a first surface and the second component has a second surface opposite to this first surface, preferably viewed in an axial and/or circumferential and/or radial direction. An axial direction is parallel to a rotational or (main) machine axis of the turbine or compressor stage or flow machine, a circumferential direction is a circumferential or rotational direction around this rotational or (main) machine axis, and a radial direction is perpendicular to this axial and circumferential direction, preferably away from the rotational or (main) machine axis. Vibration amplitudes and/or propagation can be reduced particularly advantageously by surfaces that face each other in at least one of the aforementioned directions and that are in contact or come into contact as a result of vibration.

According to an embodiment of the present disclosure, the first surface has a first contact area and the second surface has a first contact contour opposite this first contact area, which are designed or configured to contact each other at least temporarily.

According to an embodiment of the present disclosure, the first contact contour has
a depression, convex in shape, in particular funnel-shaped or spherical, in a further development; or
a convex or protruding edge rounded off in a further development; or
a convex or protruding tip, rounded or cut off in a further development.

Such contact contours can have an advantageous effect on the vibration propagation and/or amplitudes of the two components, thereby advantageously transferring (vibration) energy to other modes and advantageously reducing vibrations in certain modes that are particularly pronounced without such contact contours.

In an embodiment, the first contact area for contacting the first contact contour is free from ridges and recesses.

A combination that is particularly advantageous is a first contact area that is free from ridges and recesses, which contacts an edge of the recess of the first contact contour in a flat, in particular ring-shaped and/or closed manner around the recess, or forms a surface contact point with it, or is provided or designed for this purpose. In other words, the recess or indentation within an area, in which contact occurs, can provide a non-contact area that is completely enclosed within the contact plane by the area, in which contact occurs.

In some embodiments, a recess or indentation can also be formed within the first contact area, while still providing a non-contact area within an area in which contact occurs. This contact-free area is completely enclosed within the contact plane by the area, in which contact occurs.

Another combination that is particularly advantageous is a first contact area that is free from ridges and recesses, which contacts the edge of the first contact contour (idealized or viewed from a rigid-body mechanical perspective) in a linear fashion or forms a linear contact point with it or is designed or configured for this purpose.

Another combination that is particularly advantageous is a first contact area that is free from ridges and recesses, which contacts the tip of the first contact contour (idealized or viewed from a rigid-body mechanical perspective) at a point or forms a point contact with it, or is designed or configured for this purpose.

In an embodiment, the first contact area for contacting the first contact contour has a recess that is convex, in particular funnel-shaped or spherical, in a further development.

A combination that is particularly advantageous is a first contact area with a recess, or the recess, the edge of which contacts the edge of the recess of the first contact contour over a large area or forms a surface contact point with it or is provided or designed for this purpose. The surface contact point can surround the recess in a ring shape and/or enclose it completely.

In an embodiment, the first contact area for contacting the first contact contour has a convex or protruding edge that is rounded in a further development.

A combination that is particularly advantageous is a first contact area with an edge, or the edge, that contacts the edge of the first contact contour (idealized or viewed from a rigid-body mechanical perspective) in a linear manner or forms a linear contact point with it or is intended or designed for this purpose.

Another combination that is particularly advantageous is a first contact area with an edge, or the edge, that makes point contact with the edge of the first contact contour (idealized or viewed from a rigid-body mechanical perspective) or forms a contact point with it or is designed or configured for this purpose.

In an embodiment, the first contact area for contacting the first contact contour has a convex or protruding tip that is rounded or cut off in a further development.

A combination that is particularly advantageous is a first contact area with a tip, or the tip, that makes point contact with the edge of the first contact contour (idealized or viewed from a rigid-body mechanical perspective) or forms a contact point with it or is designed or configured for this purpose.

The aforementioned combinations and designs can have a particularly advantageous effect on vibration propagation and/or excitation between the two components, thereby advantageously transferring (vibration) energy to other modes and advantageously (further or particularly strongly and/or reliably) reducing vibrations in certain modes that are particularly pronounced without such contact contours.

In an embodiment, the first surface has one or more additional contact areas for contacting the second surface, and the second surface has (in each case) an additional contact contour opposite the (respective) additional contact area, spaced apart from the first contact contour and, if applicable, the other additional contact contour(s), for contacting the (respective) additional contact area; thus in a further development, the first surface has a first additional contact area for contacting the second surface, and the second surface has a first additional contact contour opposite this first additional contact area, spaced apart from the first contact contour, for contacting this first further contact area, and the first surface has a second additional contact area for contacting the second surface, and the second surface has a second additional contact contour opposite this second further contact area, spaced apart from the first and first further contact contours, for contacting this second further contact area, and, if necessary, one or more additional contact areas and contact contours.

In an embodiment, the additional contact contour has
a depression, convex in shape, in particular funnel-shaped or spherical, in a further development; or
a convex or protruding edge rounded off in a further development; or
a convex or protruding tip, rounded or cut off in a further development.

In an embodiment, one or more of the additional contact contours each have a recess that is convex in a further development, in particular funnel-shaped or spherical. In addition or alternatively, one or more of the other contact contours in an embodiment each have a convex or protruding edge that is rounded. In addition or alternatively, one or more of the other contact contours in an embodiment each have a convex or protruding tip, which is rounded or cut off in some embodiments.

In an embodiment, one or more of the additional contact areas for contacting the (corresponding) additional contact contour(s) are free from ridges and recesses.

A combination that is particularly advantageous is one or more additional contact areas that are free from ridges or recesses, each of which makes flat contact with one edge of the recess of the (corresponding) additional contact contour or forms a surface contact point with it, or is designed or configured for this purpose.

Another combination that is also particularly advantageous is one or more additional contact areas that are free from ridges or recesses, each of which contacts the edge of the (corresponding) additional contact contour (idealized or viewed from a rigid-body mechanical perspective) in a linear manner or forms a line contact point with it or is intended or designed for this purpose.

Another combination that is also particularly advantageous is one or more additional contact areas that are free from ridges or recesses, each of which contacts the tip of the (corresponding) additional contact contour (idealized or viewed from a rigid-body mechanical perspective) and forms a contact point with it, or is intended or designed for this purpose.

In an embodiment, one or more of the additional contact areas for contacting the (corresponding) additional contact contour(s) each have a recess that is convex in shape, in particular funnel-shaped or spherical.

A combination that is particularly advantageous is one or more additional contact areas, each with a recess, or the recess, the edge of which (in each case) makes surface contact with an edge of the recess of the (corresponding) additional contact contour or forms a surface contact point with it, or is provided or designed for this purpose.

In an embodiment, one or more of the additional contact areas for contacting the (corresponding) additional contact contour(s) have a convex or protruding edge that is rounded in an embodiment.

A combination that is particularly advantageous is one or more additional contact areas with (in each case) an edge, or the edge, that make linear contact with the edge of the (corresponding) additional contact contour (from an idealized or rigid-body mechanical perspective) or form a line contact point with it, or are provided or designed for this purpose.

Another combination that is particularly advantageous is one or more additional contact areas with (in each case) an edge, or the edge, that make point contact with the edge of the (corresponding) additional contact contour (from an idealized or rigid-body mechanical perspective) or form a point contact with it, or are designed or configured for this purpose.

In an embodiment, one or more of the additional contact areas for contacting the (corresponding) additional contact contour(s) have a convex or protruding tip that is rounded or cut off in a further development.

A combination that is particularly advantageous is one or more additional contact areas with (in each case) a tip, or the tip, that make point contact with the edge of the (corresponding) additional contact contour (from an idealized or rigid-body mechanical perspective) or form a point contact with it, or are designed or configured for this purpose.

The aforementioned combinations and designs can have a particularly advantageous effect on vibration propagation and/or excitation between the two components, thereby advantageously transferring (vibration) energy to other modes and advantageously (further or particularly strongly and/or reliably) reducing vibrations in certain modes that are particularly pronounced without such contact contours.

It can be particularly advantageous if two or more pairs consisting of or comprising the contact area and contact contour of the first and second components, in particular the pair (first contact area; first contact contour) and the, or at least one, pair (additional contact area; additional contact contour) are of the same type, i.e., for example, two or more point contact points formed by a tip and a contact area free from ridges or recesses, or a contact area with a convex edge or tip, or the like. Accordingly, these combinations are particularly advantageous.

It can also be particularly advantageous if two or more pairs from the contact area and contact contour of the first and second components, in particular the pair (first contact area; first contact contour) and the, or at least one, pair (additional contact area; additional contact contour) are different. Accordingly, these combinations are particularly advantageous.

In an embodiment, for one or more of the contact contours in a further development, the first and/or one or more additional contact contours, and the contact area opposite them (in each case) in a further development, corresponding to the first or (corresponding) additional contact area,
the convex tip of this contact contour and
   the counter surface free from ridges or recesses, or
   convex edge or
   convex tip
of this contact area
   or
the convex edge of this contact contour and
the convex edge of this contact area
   form a point of contact with each other.

In an embodiment, for one or more of the contact contours in a further development, the first and/or one or more additional contact contours, and the contact area opposite them (in each case) in a further development, corresponding to the first or (corresponding) additional contact area,
the convex edge of this contact contour and
   the counter surface free from ridges or recesses, or
   convex edge
of this contact area
   form a line contact point with each other.

In an embodiment, for one or more of the contact contours in a further development, the first and/or one or more additional contact contours, and the contact area opposite them (in each case) in a further development, corresponding to the first or (corresponding) additional contact area,
an edge of the recess of this contact contour and
   a counter surface free from ridges or recesses, or
   a recessed counter surface
of this contact area
   form a surface contact point with each other.

The aforementioned combinations and designs can have a particularly advantageous effect on vibration propagation and/or excitation between the two components, thereby advantageously transferring (vibration) energy to other modes and thus advantageously reducing vibrations in certain modes that are particularly pronounced without such contact contours.

In an embodiment, the one with the first and second surfaces is arranged on a blade shroud and the other with the first and second surfaces is arranged on an adjacent blade shroud.

In an embodiment, the one with the first and second surfaces is arranged on a running blade and the other with the first and second surfaces is arranged on a body movably arranged in a cavity of a platform of this running blade, which is preferably designed to produce impacts with (an inner wall of) the cavity during operation.

In an embodiment, the one with the first and second surfaces is arranged on a vane cluster and the other with the first and second surfaces is arranged on a housing or sealing ring.

In an embodiment, the one with the first and second surfaces is arranged on a disc with integrated guide vanes (“BladedDISK” or “Blisk”) and the other with the first and second surfaces is arranged on a damper ring or damper segment.

In these assemblies in particular, vibration propagation and/or excitation between the two components can be influenced in a particularly advantageous manner, especially due to the aerodynamic, mechanical, and thermal loads and design constraints that occur during operation, and thus (vibration) energy can be advantageously transferred to other modes, thereby advantageously reducing vibrations in certain modes that are particularly pronounced without such contact contours.

In an embodiment, the first surface is flat, preferably planar, outside its contact areas. In an embodiment, the first surface is cylindrical outside its contact areas. In another embodiment, the first surface is spherical outside its contact areas. In another embodiment, the first surface is conical outside its contact areas.

In an embodiment, the second surface is flat outside its contact contours, preferably planar. In an embodiment, the second surface is cylindrical outside its contact contours. In an embodiment, the second surface is spherical outside its contact contours. In another version, the second surface is conical outside its contact contours.

The aforementioned combinations and designs can have a particularly advantageous effect on vibration propagation and/or excitation between the two components, thereby advantageously transferring (vibration) energy to other modes and advantageously (further or particularly strongly and/or reliably) reducing vibrations in certain modes that are particularly pronounced without such contact contours.

According to an embodiment of the present disclosure, an assembly arrangement has several, in particular three or more, components which together form a ring, wherein, in particular when viewed in the circumferential direction, adjacent components form a first and second component of an assembly described herein, and all first components (each case relative to one another) have identical first contact areas and all second components (each relative to one another) have identical first contact contours, which (each) form identical contact points with these first contact areas. In an embodiment, all first components (each relative to one another) have identical additional contact areas and all second components (each relative to one another) have identical additional contact contours, which (each) form identical contact points with these additional contact areas. In an embodiment, the assembly arrangement exhibits cyclic symmetry (with regard to) pairs of contact areas and contact contours.

Such cyclically symmetrical (distributed) contact points allow (vibration) energy to be transferred to higher modes, thereby advantageously reducing vibrations in fundamental or lower modes, which are particularly pronounced without such contacts.

According to an embodiment of the present disclosure, an assembly arrangement comprises several, in particular three or more, components which together form a ring, wherein, in particular when viewed in the circumferential direction, adjacent components form a first and second component of an assembly described herein, and at least two first components have different first contact areas and/or at least two second components have different first contact contours, so that these first contact areas and first contact contours form different contact points. In an embodiment, the assembly arrangement exhibits no cyclic symmetry or broken cyclic symmetry with regard to/in pairs of first contact area—first contact contour.

Such non-cyclically symmetrical (distributed) contact points between first contact areas and first contact contours allow (vibration) energy to be transferred to other modes, in particular those of the same mode family (e.g. 1f (flap mode), 1cd (coupled disk mode), 1t (torsion mode), 1c (chordwise mode) or combinations thereof, such as 1f+1cd) and/or to adjacent vibration node diameters, thereby advantageously reducing vibrations that are particularly pronounced without such contacts. Accordingly, the ring has several, preferably adjacent, vibration node diameters in one design.

Further advantageous improvements to the present disclosure are apparent from the following description of preferred embodiments.

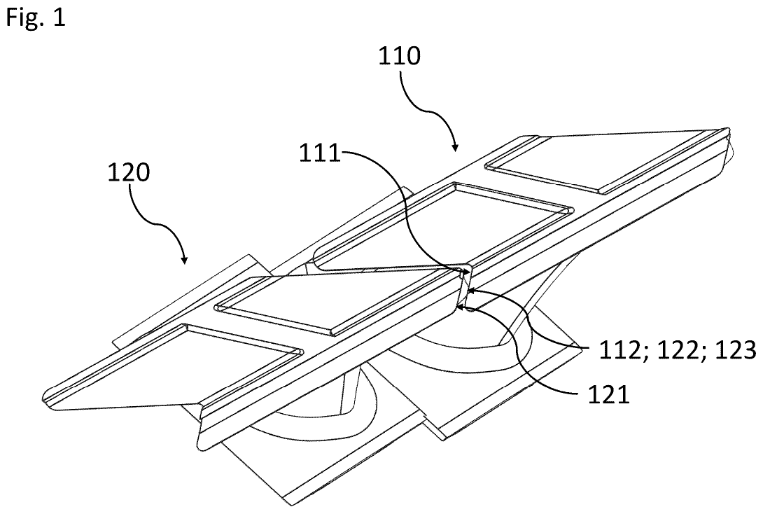

FIG. 1 shows an assembly according to an embodiment of the present disclosure in perspective view. The assembly includes a first component in the form of a blade 110 with a first surface 111 on a blade shroud and a second component in the form of an adjacent blade 120 with a second surface 121 opposite the first surface on a blade shroud, wherein the first surface has a first contact area 112 free from ridges and recesses for contacting the second surface, and the second surface has a first contact contour 122 opposite this first contact area, which has a convex edge 123, such that the convex edge 123 and the surface 112 free from ridges and recesses form a line contact point with each other. The blades 110, 120 are designed as turbine blades, and in a further development as low-pressure turbine blades.

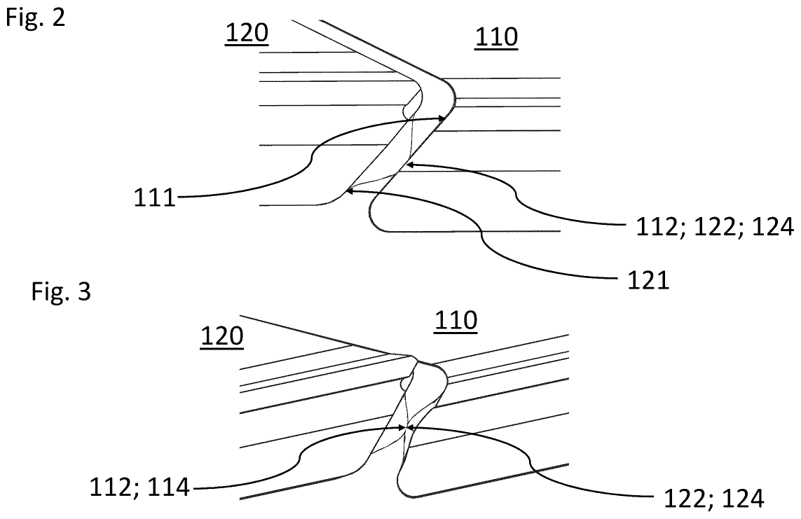

FIG. 2 shows an assembly according to another embodiment of the present disclosure in an enlarged section. The assembly consists of or comprises the aforementioned (low-pressure) turbine blades 110, 120, where, however, in contrast to the design shown in FIG. 1, the second surface on the blade shroud has a first contact contour 122 opposite the first contact area 112 free from ridges and recesses, which has a convex tip 124, so that the convex tip 124 and the counter surface free from ridges and recesses form a point contact with each other.

FIG. 3 shows an assembly according to a further embodiment of the present disclosure corresponding to the representation in FIG. 2. The assembly consists of or comprises the aforementioned ((low-pressure) turbine) blades 110, 120, whereby, in contrast to the design shown in FIG. 2, the first contact area 112 has a convex tip 114, so that the convex tips 114, 124 form a point contact with each other.

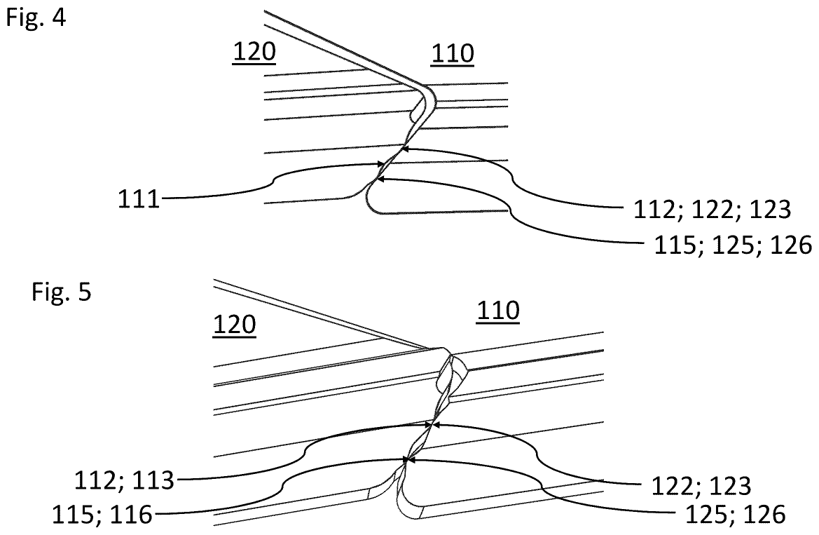

FIG. 4 shows an assembly according to a further embodiment of the present disclosure corresponding to the representation in FIG. 2. The assembly consists of or comprises the aforementioned (low-pressure) turbine blades 110, 120, whereby, in contrast to the design shown in FIGS. 1, 2, the second surface on the blade shroud not only has a first contact contour 122 with a convex edge 123 opposite the first contact area 112 free from ridges and recesses, so that this convex edge 123 and the contact surface 112 free from ridges and recesses form a line contact point with each other, but the second surface additionally has a further contact contour 125 with a (further) convex edge 126 opposite a further contact area 115 of the first surface 111 that is free from ridges and recesses, which forms a further line contact point (double line contact) with the further contact surface that is free from ridges and recesses.

FIG. 5 shows an assembly according to a further embodiment of the present disclosure corresponding to the representation in FIG. 4. The assembly consists of or comprises the aforementioned ((low-pressure) turbine) blades 110, 120, but in contrast to the design shown in FIG. 4, the first contact area 112 has a convex edge 113 and the further contact area 115 has a (further) convex edge 116, so that the edges 113, 123 and the edges 116, 126 each form a line contact point (double line contact).

FIG. 6 shows an assembly according to a further embodiment of the present disclosure with a first component in the form of a blade, in a turbine blade embodiment in a further development of low-pressure turbine blades, 210, and a second component in the form of an impact body 220, which is movably arranged in a cavity 211 of a platform 212 of this running blade. An (inner) wall of the cavity forms a first surface or a first contact area, which in one embodiment is free from ridges and recesses.

FIG. 7 shows the impact body 220, which has a second surface 221 that has a first contact contour 222 for contacting a first contact area of the (first) surface of the cavity 211 with a convex edge 223 that is oriented transversely to a longitudinal direction of the body.

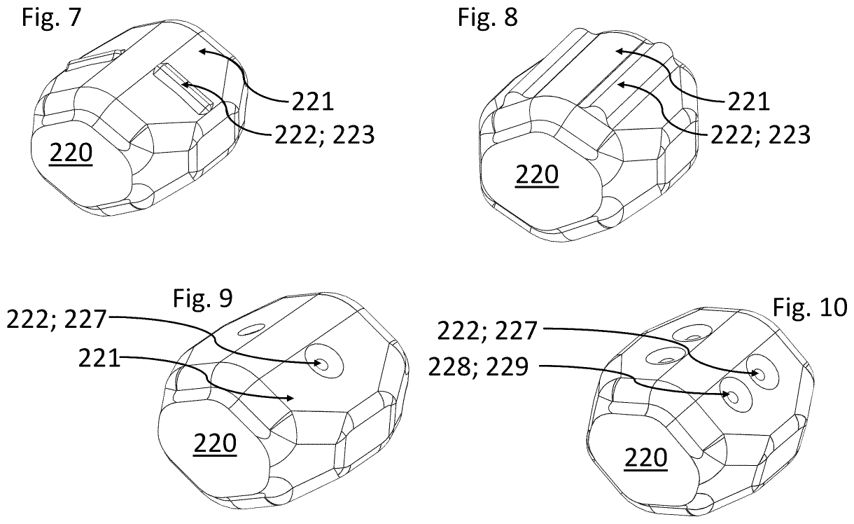

FIG. 8 shows the impact body 220 of an otherwise identical modification of the design shown in FIG. 6, in which the edge 223 is oriented in the longitudinal direction of the body.

FIG. 9 shows the impact body 220 of a further modification of the design shown in FIG. 6, which is otherwise identical in construction, in which the first contact contour 222 for contacting a first contact area of the (first) surface of the cavity 211 has a funnel-like recess 227.

FIG. 10 shows the impact body 220 of a further modification of the design shown in FIG. 6, which is otherwise identical in construction, in which the second surface 221 has a further contact contour 228 for contacting a further contact area of the (first) surface of the cavity 211 with a further funnel-like recess 229.

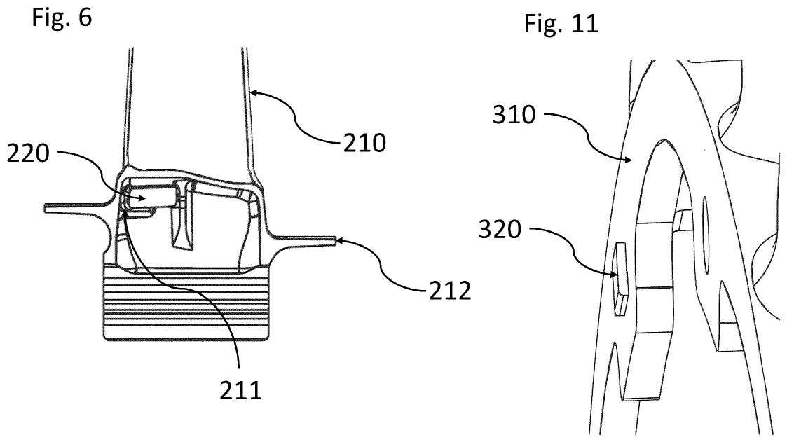

FIG. 11 shows an assembly according to another embodiment of the present disclosure with a first component in the form of a blisk 310 and a second component in the form of a damper segment 320. An (inner) wall of the blisk, which faces a cross member 320.2 protruding from a clamp 320.1 of the damper segment 320, forms a first surface or a first contact area, which in an embodiment is free from ridges and recesses. The blisk in an embodiment is a type of blisk used in a compressor stage.

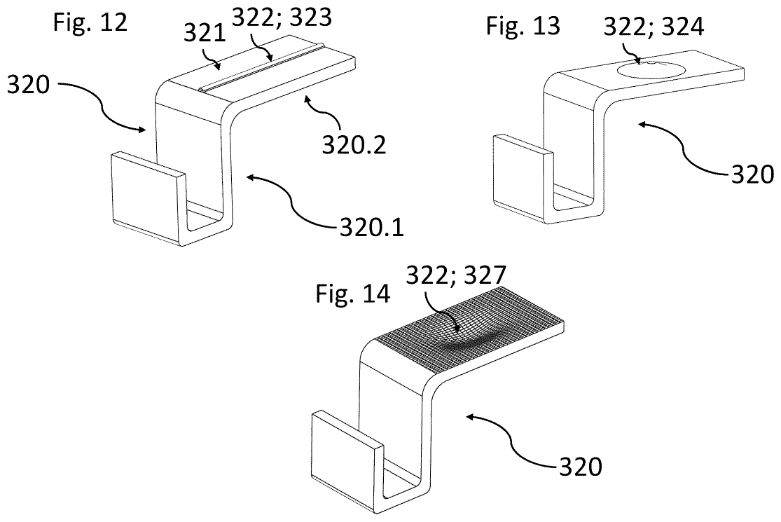

FIG. 12 shows the damper segment 320, which or whose transverse leg 320.2 has a second surface 321 that has a first contact contour 322 for contacting a first contact area of a first surface of the blisk 310 with a convex edge 323.

FIG. 13 shows the damper segment 320 of an otherwise identical modification of the design shown in FIG. 11, in which the first contact contour 322 for contacting a first contact area of the first surface of the blisk 310 has a cut-off tip 324.

FIG. 14 shows the damper segment 320 of another modification of the design shown in FIG. 11, which is otherwise identical in construction, in which the first contact contour 322 for contacting a first contact area of the first surface of the blisk 310 has a spherical recess 327.

In a variation, instead of the damper segment, a damper ring known per se can also be provided with the respective first contact contour.

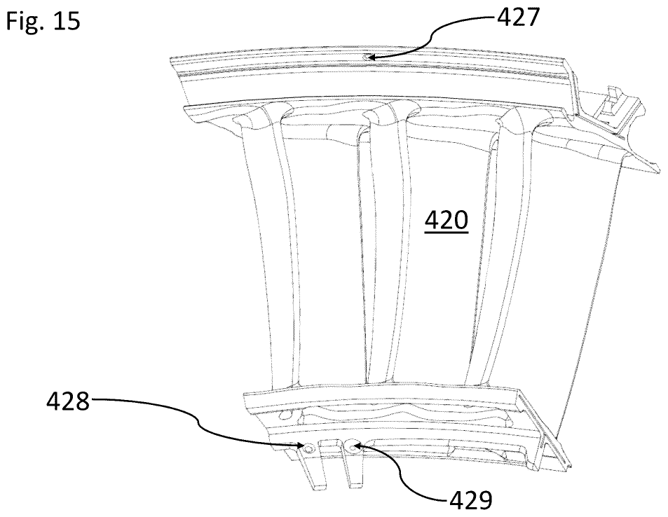

FIG. 15 shows a second component of an assembly according to a further embodiment of the present disclosure in the form of a guide vane or vane cluster 420 (for) a turbine or compressor stage in perspective view. A first component can be in the form of a housing or sealing ring, in a design with an inner sealing ring (“inner air seal,” IAS).

This second component also has a second surface with a first contact contour for contacting an opposing first contact area of a first surface of the first component, wherein this first contact contour has a recess 427 or 428. In addition, a further contact contour spaced apart from the first contact contour with recess 428 is provided for contacting a further contact area of the first surface of the first component, which has a recess 429. Recess 427 is located in the outer cover band of the vane cluster, while recesses 428 and 429 are located at the base and the interface with the IAS, respectively.

The above refers to blade shrouds (see FIGS. 1-5), showing them in a design for turbine blades, in a further development for low-pressure turbine blades, platform (impact body) dampers (see FIGS. 6-10) in a design for turbine blades, in a further development for low-pressure turbine blades, and/or radial inner platforms, blisks (see FIGS. 11-14), in a design for compressors (or compressor stages), with damper segments or rings, and vane clusters in combination with a housing or sealing ring as the first component (see FIG. 15), particularly advantageous designs or applications of the present disclosure, without being limited thereto.

In this disclosure, “includes an X” generally does not imply an exhaustive list, but is short for “includes at least one X” as well as “includes two or more Xs” and “includes Y in addition to X.” Although the preceding description has explained exemplary embodiments, it should be noted that a variety of modifications are possible. It should also be noted that the exemplary descriptions are merely examples and are not intended to limit the scope of protection, applications, or structure in any way. Rather, the preceding description provides the skilled person with a guide for implementing at least one exemplary embodiment, whereby various modifications, in particular with regard to the function and arrangement of the described components, can be made without departing from the scope of the present disclosure and these equivalent combinations of features.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE LIST

110 blade (first component)
111 first surface
112 first contact area
113 edge
114 rounded tip
115 additional contact area
116 edge
120 blade (second component)
121 second surface
122 first contact contour
123 edge
124 rounded tip
125 additional contact contour
126 edge
210 blade (first component)
211 cavity
212 platform
220 impact body (second component)
221 second surface
222 first contact contour
223 edge
227 recess
228 additional contact contour
229 recess
310 blisk (first component)
320 damper segment (second component)
320.1 bracket
320.2 crossbar
321 second surface
322 first contact contour
323 edge
324 cut-off tip
327 recess
420 guide vane/vane cluster
427, 428, 429 recess

1. An assembly comprising:
a first component and a second component configured for arrangement in a same turbine or compressor stage of an aircraft engine,
wherein the first component has a first surface and the second component has a second surface opposite the first surface,
wherein the first surface has a first contact area configured for contacting the second surface, and
wherein the second surface has a first contact contour opposite the first contact area configured for contacting the first contact area, the first contact contour having a recess or a convex edge or a convex tip.

2. The assembly according to claim 1, wherein the first contact area for contacting the first contact contour is free from ridges and recesses or has a recess or a convex edge or a convex tip.

3. : The assembly according to claim 1, wherein the first surface has at least one further contact area for contacting the second surface, and the second surface has a further contact contour opposite the further contact area and spaced apart from the first contact contour for contacting the further contact area, wherein the further contact contour has a recess or a convex edge or at least one convex tip.

4. The assembly according to claim 3, wherein the further contact area for contacting the further contact contour is free from ridges and recesses or has a recess or a convex edge or a convex tip.

5. The assembly according to claim 1, wherein for at least one contact contour of the first contact contour and/or the further contact contour and its respective opposing first contact area or further contact area:
the at least one contact contour and the respective opposing first contact area and/or further contact area form a point contact with each other; and/or
the at least one contact contour and the respective opposing first contact area and/or further contact area form a line contact point with each other; and/or
the at least one contact contour and the respective opposing first contact area and/or further contact area form a surface contact point with each other.

6. The assembly according to claim 1, wherein
one of the first and second surfaces is arranged on a blade shroud, and an other of the first and second surfaces is arranged on an adjacent blade shroud; or
one of the first and second surfaces is arranged on a blade and the other of the first and second surfaces is arranged on a body movably arranged in a cavity of a platform of the blade; or
one of the first and second surfaces is arranged on a guide vane cluster and the other of the first and second surfaces arranged on a housing or sealing ring; or
one of the first and second surfaces is arranged on a disc with integrated guide vanes and the other of the first and second surfaces is arranged on a damper ring or damper segment.

7. The assembly according to claim 1, wherein the first surface outside its contact areas is flat or cylindrical or spherical or conical and/or the second surface outside its contact contours is flat or cylindrical or spherical or conical.

8. An assembly arrangement comprising several components which together form a ring, wherein adjacent components of the assembly arrangement form the first and second component of the assembly according to claim 1, and wherein all first components have identical first contact areas and all second components have identical first contact contours which form identical contact points with the first contact areas.

9. The assembly arrangement comprising several components which together form a ring, wherein adjacent components of the assembly arrangement form the first and second component of the assembly according to claim 1, and wherein at least two first components have different first contact areas and/or at least two second components have different first contact contours, such that the first contact areas and first contact contours form different types of contact points.

10. The assembly arrangement according to claim 9, wherein the ring has a plurality of vibration node diameters.

11. A turbine or compressor stage for an aircraft engine, with at least one assembly arrangement according to claim 1.

12. An aircraft engine gas turbine, comprising at least one of the turbine gas stage or the compressor stage according to claim 11.

13. The assembly according to claim 5, wherein for the least one contact contour and the respective opposing first contact area or further contact area, the at least one contact contour and the respective opposing first contact area and/or further contact area form the a surface contact point with each other, the surface contact point surrounding a recess in a ring shape and/or completely enclosing the recess.
